(19) United States
(12) Patent Application Publication
(10) Pub. No.: US 2009/0070346 A1
(43) Pub. Date: Mar. 12, 2009

(54) Systems and methods for clustering information

(76) Inventors: Antonio Savona, Sora (FR) (IT); Antonino Gulli, Pisa (IT); Luca Foschini, Santa Barbara, CA (US); Giovanni Deretta, Olbia (SS) (IT)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/899,832

(22) Filed: Sep. 6, 2007

(51) Int. Cl. G06F 7/06

(52) U.S. Cl. 707/100

(57) ABSTRACT

Systems and methods for clustering news information are disclosed. The news information is clustered to form clusters to include one or more of articles, blogs, images, videos and the like. The news information is organized according to topic and/or temporal information. The clustered news information can be presented to a user who can browse or search the clustered news information.

### FIELD

This invention relates to the field of search engines and, in particular, to systems and methods for searching and browsing information using temporal clustering.

### BACKGROUND

The Internet is a global network of computer systems and websites. These computer systems include a variety of documents, files, databases, and the like, which include information covering a variety of topics. It can be difficult for users of the Internet to locate information on the Internet. Search engines are often used by people to locate information on the Internet. Search engines are also sometimes used to locate news information.

Currently, when users browse for news information, the user is presented with several news categories, such as, for example, top stories, U.S., world, business, health, technology, entertainment and the like. When a user selects a news category, several selectable news articles related to the selected news category are then presented to the user. Similarly, when a user enters a search query for a particular news story, the user is typically presented with several selectable news articles related to the search query. Sometimes, a selected news article may include a link to other related news articles.

However, most search engines and news sites currently determine that articles are related with an exact title match. In addition, most search engines and news sites currently do not use the temporal information of the news article in organizing the news information or allow users of the sites to search or browse news information according to the temporal information.

### SUMMARY

A method for presenting information in accordance with one embodiment of the invention is disclosed. The method includes clustering textual news information to form a plurality of topic clusters; identifying textual information associated with visual news information; and associating visual news information with at least one of the plurality of topic clusters using the textual information.

The textual news information may include news articles and/or news blogs. The visual news information may include images and/or videos. The textual information may include metadata.

Identifying textual information associated with visual news information may include converting audio data of the video to textual information.

The method may also include ranking the plurality of topic clusters. The method may also include ranking the textual news information in each of the plurality of topic clusters.

A method for organizing related news information in accordance with one embodiment of the invention is disclosed. The method includes merging differing news information types to form merged news information; and clustering the merged news information to form a plurality of topic clusters, wherein the differing news information types are selected from the group consisting of articles, blogs, images and videos.

Merging differing news information types to form merged news information may include merging articles and blogs.

The method may further include associating a multimedia object with the topic clusters. The multimedia object may be selected from the group consisting of images, videos and combinations thereof.

A search system in accordance with one embodiment of the invention is also disclosed. The search system includes a news information receiver to receive news information, wherein the news information comprises textual information and multimedia objects; a merging unit to merge the textual news information; and a cluster unit to cluster the textual news information according to a topic of the news information.

The system may also include a server is further to present the news information to a user.

The method may also include a search engine connected to the server, the search engine to receive a search query of the news information.

The server may also provide a search result to the search engine in response to the search query.

The system may also include a ranking unit to rank clustered news information.

The system may also include an associating unit to associate the multimedia objects with the clustered news information according to the topic of the news information. The multimedia objects may be selected from the group consisting of images, videos and combinations thereof.

### BRIEF DESCRIPTION OF THE DRAWINGS

The invention is described by way of example with reference to the accompanying drawings, wherein:

FIG. 1 is a block diagram illustrating a system for natural language service searching in accordance with one embodiment of the invention;

FIG. 2A is a block diagram illustrating organization of news information in accordance with one embodiment of the invention;

FIG. 2B is a block diagram illustrating organization of news information in accordance with one embodiment of the invention;

FIG. 3 is a flow diagram illustrating a method for clustering multiple types of information in accordance with one embodiment of the invention;

FIG. 4 is a block diagrams of a multi-source clustering system in accordance with one embodiment of the invention;

FIG. 5 is a flow diagram illustrating a method for associating a multimedia object with a cluster and/or chain in accordance with one embodiment of the invention;

FIG. 6 is a schematic view of a user interface for locating news information in accordance with one embodiment of the invention;

FIGS. 7A-7H are schematic views of a user interface for locating news information in accordance with one embodiment of the invention;

FIGS. 8A-8B are schematic views of a user interface for locating news information in accordance with one embodiment of the invention;

FIG. 9 is a schematic view of a user interface for presenting news information in accordance with one embodiment of the invention; and

FIGS. 10A-10B are schematic views of a user interface for presenting clustered news information of different types.

### DETAILED DESCRIPTION

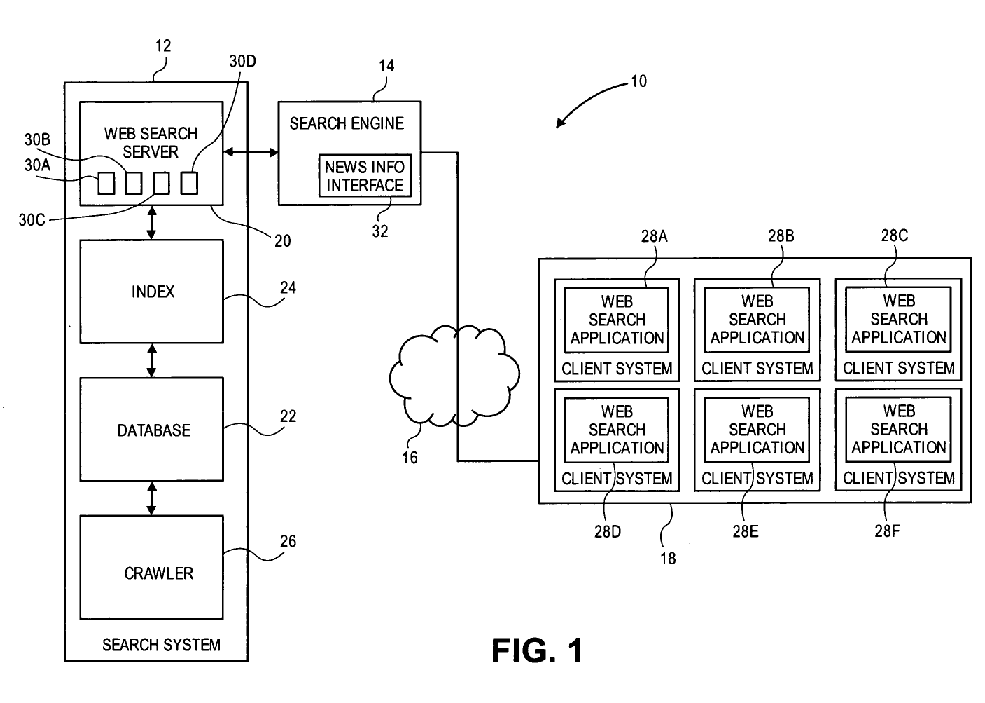

FIG. 1, of the accompanying drawings, shows a network system 10 which can be used in accordance with one embodiment of the present invention. The network system 10 includes a search system 12, a search engine 14, a network 16, and a plurality of client systems 18. The search system 12 includes a server 20, a database 22, an indexer 24, and a crawler 26. The plurality of client systems 18 includes a plurality of web search applications 28a-f, located on each of the plurality of client systems 18. The server 20 includes a plurality of databases 30a-d. The search engine 14 may include a news information interface 32.

The server 12 is connected to the search engine 14. The search engine 14 is connected to the plurality of client systems 18 via the network 16. The server 20 is in communication with the database 22 which is in communication with the indexer 24. The indexer 24 is in communication with the crawler 26. The crawler 26 is capable of communicating with the plurality of client systems 18 via the network 16 as well.

The web search server 20 is typically a computer system, and may be an HTTP server. It is envisioned that the search engine 14 may be located at the web search server 20. The web search server 20 typically includes at least processing logic and memory.

The indexer 24 is typically a software program which is used to create an index, which is then stored in storage media. The index is typically a table of alphanumeric terms with a corresponding list of the related documents or the location of the related documents (e.g., a pointer). An exemplary pointer is a Uniform Resource Locator (URL). The indexer 24 may build a hash table, in which a numerical value is attached to each of the terms. The database 22 is stored in a storage media, which typically includes the documents which are indexed by the indexer 24. The index may be included in the same storage media as the database 22 or in a different storage media. The storage media may be volatile or non-volatile memory that includes, for example, read only memory (ROM), random access memory (RAM), magnetic disk storage media, optical storage media, flash memory devices and zip drives.

The crawler 26 is a software program or software robot, which is typically used to build lists of the information found on Web sites. Another common term for the crawler 26 is a spider. The crawler 26 typically searches Web sites on the Internet and keeps track of the information located in its search and the location of the information.

The network 16 is a local area network (LAN), wide area network (WAN), a telephone network, such as the Public Switched Telephone Network (PSTN), an intranet, the Internet, or combinations thereof.

The plurality of client systems 18 may be mainframes, minicomputers, personal computers, laptops, personal digital assistants (PDA), cell phones, and the like. The plurality of client systems 18 are capable of being connected to the network 16. Web sites may also be located on the client systems 18. The web search application 28a-f is typically an Internet browser or other software.

The databases 30a-d are stored in storage media located at the server 20, which may include clustered news information, as will be discussed hereinafter. The storage media may be volatile or non-volatile memory that includes, for example, read only memory (ROM), random access memory (RAM), magnetic disk storage media, optical storage media, flash memory devices and zip drives.

In use, the crawler 26 crawls websites, such as the websites of the plurality of client systems 18, to locate information on the web. The crawler 26 employs software robots to build lists of the information. The crawler 26 may include one or more crawlers to search the web. The crawler 26 typically extracts the information and stores it in the database 22. The indexer 24 creates an index of the information stored in the database 22. Alternatively, if a database 22 is not used, the indexer 24 creates an index of the located information and the location of the information on the Internet (typically a URL).

The crawler 26 or a dedicated news information crawler (not shown), may search the web for news information and store the news information and/or properties of the news information in index and/or database, and/or in a dedicated news index and/or news database (not shown). News information may include news articles, blogs, RSS/Atom feeds, video news, or any stream of textual information enriched with other media content, such as, images, video, audio or other multimedia objects. It will be appreciated that different crawlers may be provided for each type of news information. Searchable news information, as will be described hereinafter, may be stored in one or more of databases 30a-d. The news information interface 32 may be connected to the one or more databases 30a-d having news information stored therein, database 22 and/or indexer 24.

When a user of one of the plurality of client systems 18 enters a search on the web search application 28, the search is communicated to the search engine 14 over the network 16. The search engine 14 communicates the search to the server 20 at the search system 12. The server 20 accesses the index and/or database to provide a search result, which is communicated to the user via the search engine 14 and network 16.

If a user of one of the plurality of client systems 18 accesses the news information interface 32 through the web search application 28, the search engine 14 still communicates the search to the server 20, which provides a search result. The search result may be obtained from either or both the web index and the dedicated news information index. The search result is typically searchable news information. As will be described hereinafter, the news information is searchable using a search query, such as a keyword or natural language search, or using a browser.

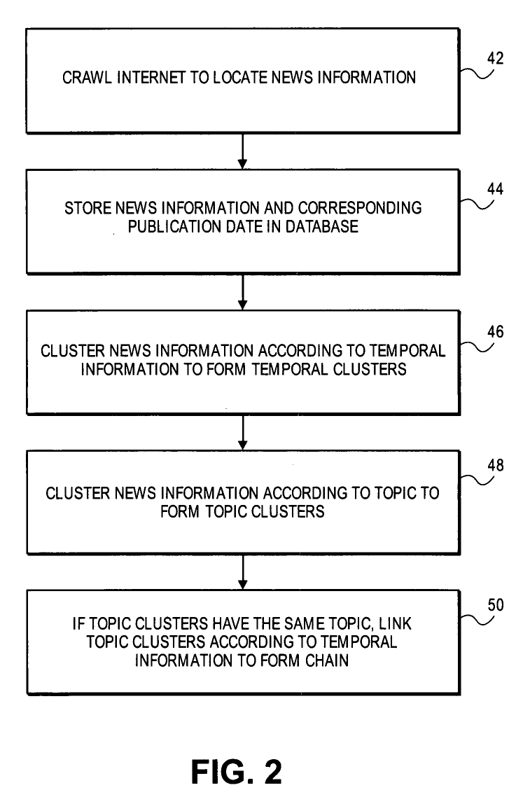

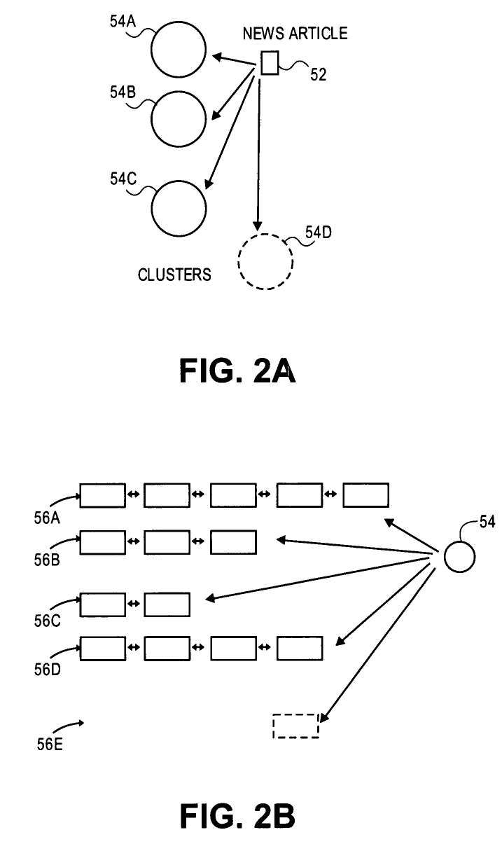

FIG. 2 shows a method 40 for clustering a stream of information in accordance with one embodiment of the invention. At block 42, a crawler, such as crawler 16 (FIG. 1) or a dedicated news information crawler, searches the Internet to locate news information. At block 44, located news information (and/or properties about the news information) is stored in an index and/or database. At block 46, the news information is clustered according to temporal information to form temporal clusters. At block 48, the temporal clusters are clustered according to topic to form topic clusters. At block 50, if topic clusters have the same topic, the topic clusters are linked together to form a chain according to the temporal information.

FIG. 2A shows diagrammatically the process for identifying a topic cluster for a news article. For each news article 52, the system determines whether an existing cluster 54a-c is related to the same topic as the news article 52. If the news article 52 is related to the same topic as one of the existing clusters 54a-c, the news article 52 is added to the corresponding existing cluster. If the news article 52 is not related to the same topic as one of the existing clusters 54a-c, a new cluster 54d is formed for the topic corresponding to the news article 52.

FIG. 2B shows diagrammatically the process for identifying a topic chain for a cluster. For each cluster 54, the system determines whether an existing chain 56a-d is related to the same topic as the cluster 54. If the cluster 54 is related to the same topic as one of the existing chains 56a-d, the cluster 54 is added to the corresponding existing chain. If the chain 54 is not related to the same topic as one of the existing clusters 56a-d, a new chain 56e is formed for the topic corresponding to cluster 54.

In one embodiment, temporal clustering is carried out on daily basis. In this case, the chains of previous days may be consolidated and stored off-line for efficiency reasons. The clusters formed for the current day may be created every m minutes, for example, and dynamically merged with the offline chains.

Each of the clusters and/or chains is typically stored in memory. Typically, the external memory includes a database, such as one or more of databases 30a-d, and/or an index, as described hereinabove.

The temporal information used to cluster the information is typically the publication date and/or time, posting date and/or time, clustering date and/or time (i.e., when the news information is clustered) or crawling date and/or time (i.e., when the news information is located, indexed and/or stored by the crawler).

It will be appreciated that although the above process has been described as first clustering the stream of information according to temporal information and, then, topic, the process may also be performed by first clustering the stream of information according to topic and, then, temporal information.

The process for clustering a stream of information typically occurs periodically. The crawler 26 typically locates more news information each time it searches the Internet; thus, the above process may occur concurrently with crawling. It will be appreciated that the news information may also be received by the system via streaming feeds, such as, for example, RSS. In one embodiment, a window of time ω, such as an hour, a day, a week, etc. is selected for clustering. It will also be appreciated that news stories in different categories may be clustered at different periods of time and, thus, different periods of time can be selected for different news categories. For example, business news is typically updated more frequently than world news; thus, the time increment for clustering business news may be more frequent (e.g., every five minutes) than the time increment for clustering world news (e.g., every hour).

A clustering algorithm is used to cluster the information according to the selected window of time ω. New clusters can be periodically linked to chains, or new topic clusters can be identified, periodically. The new clusters are compared to other clusters to discover similarities in topic. When similarities are found among clusters in different time windows, the clusters are linked together to form a chain or are added to a preexisting chain. This comparison with clusters in previous time windows can stop if no similar information is found for a period of time proportional to the extension of the current cluster or to an extension of the chain. The chain of clusters is organized in a hierarchy according to the temporal information of each cluster: the most recent cluster is typically displayed at the top of the chain and the oldest cluster is typically displayed at the bottom of the chain.

In order to determine whether two news stories or two clusters are related to the same topic, a clustering algorithm is used. This algorithm is typically applied to the title of the story. The algorithm may also or alternatively be applied to each of the news articles or other portions of the news articles (e.g., other than the title of the news articles) may be compared using the algorithm, as well. For example, the algorithm may be applied to the body, abstract or any meta-information or other source of textual information that may be useful for identifying a topic of an article.

The algorithm includes a distance metric D and a set of news stories N₁ . . . Nₙ. The algorithm determines that a cluster includes either a single news story or a cluster C plus a news story Nᵢ such that at least a news story Nⱼ and C exists. The algorithm requires that the distance metric, D(Nᵢ, Nⱼ), be less than d, a threshold, to add a news story Nᵢ to a news story Nⱼ or a cluster C (i.e., determine the news stories are related).

In one embodiment, the distance metric, D(Nᵢ, Nⱼ), is D(Nᵢ, Nⱼ)=1-cw(Nᵢ, Nⱼ)/min(len(Nᵢ), len(Nⱼ)), where cw is the number of words that Nᵢ and Nⱼ have in common, and len is the length in words. It will be appreciated that other distance metrics may also be used. It will be appreciated that words can be weighted using well-known metrics, such as, for example, TF-IDF, BM25, or other metrics.

After it is determined that the stories are related, the text is extracted from the stories. The stories are then sorted from the last time slot in time descending order. Each article is assigned to a ring, which is initially made up of the news article itself. For each text T_{J} of a list of related stories, the distances (T_{J}, T_{J-1}), (T_{J}, T_{J-2}) . . . (T_{J}, T₀) in a cycle are determined. If the text T_{J} is found to be similar to the text T₁, then the rings to which Tᵢ and Tⱼ belong are joined.

The distance D₁(C,N) is defined and expresses the distance between a chain C and a cluster N. Each cluster N is added to the tail of a chain C if the chain has a distance D₁ smaller than a threshold. The Distance D₁ is defined in the following way: given a chain C of N articles C₁ . . . C_{N} and a cluster c of n articles C₁ . . . Cₙ, the distance D₁(C,c) is given by (MIN(D(c₁,C₁) . . . D(c₁,C_{N}))+ . . . +MIN(D(cₙ,C₁) . . . (cₙ,C_{N})))/n. In one embodiment, the mean of all the minimal distances of each article cᵢ to some article Cⱼ is lowered by a factor 1/k, where k>=1, and where k is a logarithmic function of the temporal distance of the news articles being compared. A new chain is started with cluster N if the distance D₁ is larger than the threshold.

To prevent erroneous cluster or chain aggregation based on similarity between text driven by the presence of words that are meaningless to the news story itself, such as the name of the agency/source or other common terms, a stop-list system may be used to mark words in titles that are not used in the computation of the D distance. The stop-lists containing the words to stop in a text may be different for each category. The stop-lists may be dynamically updated computing the most frequent words of the category dictionary, and adding the sublist to a short static list. The stop list and/or short static list can also be manually edited during tuning of the system.

The above algorithm can reveal paths among stories. For example, the texts “Bird Flu Spreads in Europe,” “H5-N1 Spreads in Europe,” “H5-N1 Diffusion in Europe Grows,” and “H5-N1 Diffusion Further Grows” are all clustered together using the algorithm because they are related, even though they have an empty intersection.

Alternatively, similarities among news stories may be identified by searching the articles for keywords. The keywords can then be compared to determine whether a particular news story is related to another news story.

The category of each news information and/or cluster may also be identified. A set of news sources are used to train a classifier for each category C. These sources are a trusted source for the category C. The classifier (e.g., bayesian or SVM) is then used to classify the remaining set of news articles. The classifier may be trained for each defined category C.

The clustering algorithm groups news according to syntactical similarities to create basic clusters. Basic clusters are typically small and are extremely focused. The similarity is computed using a distance function D which is a combination of an LCS distance over the body of the news articles and a set of words distance over the titles. A basic cluster may be either a single news story n, or the union of a basic cluster N and a news item m for which at least a news item nᵢ exists in N such that D (m, nᵢ)<ε. ε is typically a low threshold. The threshold ε may vary according to the temporal distance between the news items that are being compared. Two news items that are distant in time typically are less likely to be about the same topic because news stories tend to propagate continuously over a certain amount of time. After the set of basic clusters are created, the clusters are analyzed to remove stop words.

A set of features is computed for each cluster. The features are also referred to as labels. A label is essentially a meaningful frequently repeated pattern over the sum of all the text of a basic cluster. There are two types of labels: generic labels (or terms) and entities. Each label also has a statistical value aggregated with it. An example of a set of labels for a cluster is: {Saddam[10 . . . ], hanging[8 . . . ], comments[8 . . . ], Bush[7 . . . ], violence[5 . . . ], negative[5 . . . ], George[3 . . . ], execution[3 . . . ], Iraq[3 . . . ], death[3 . . . ] . . . }. The square brackets include a set of statistical data for each label. In one embodiment, the statistical data refers to a normalized number of occurrences. It will be appreciated that words can be weighted using other well-known metrics, such as, for example, TF-IDF, BM25, or other metrics.

After the set of labels for each cluster has been generated, the basic clusters are compared pairwise according to a comparison distance. The comparison distance computes weighted overlapping labels. In one embodiment, the weight is the difference in the stats for the same label in two different clusters. If a match occurs and if the label is also an entity, the contribution to the sum is boosted. If an entity occurs in different clusters, it is presumed that the clusters belong to the same topic. If the sum of all the similarities is higher than a given threshold, then the clusters are merged. The merging process may repeat iteratively until a convergence is reached. Convergence occurs when a whole set of pairwise comparisons has been performed without any merging. The result of this process is a set of final clusters.

After the clusters are formed, the news item that best represents the cluster is identified. In one embodiment, the representative news item provides the title to the cluster and may be shown in the current page each time that cluster is on display. Given N1 and N2, two generic news items, the ranking ordering is computed as follows: If (Feedrank(N₁)>FeedRank(N₂))ICR(N₁)>ICR(N₂); else If (Feedrank(N₁)<FeedRank(N₂)) ICR(N₁)<ICR(N₂); else // coming from feeds with the same feedrank, If (AGE(N₁)>AGE(N₂)) ICR(N₁)<ICR(N₂); else ICR(N₁)>ICR(N₂). In other words, the representative news item is the freshest one among those coming from the feeds with the highest feedrank. The feedrank is the rank assigned to the news source.

When clusters are stored, the clusters are ranked. This ranking is computed after clusters are formed in a definitive way, that is no news item can join that cluster anymore. This happens when, at the beginning of a new day, the program “finalizes” the clusters of the day before.

The static cluster ranking of a cluster C is computed as follows: c1: the number of news items in C; FW(ni) a static vector that maps a feedrank into a weight>=1.0; SCR(C)=c1*F, where F=SUMi(FW(feedrank(ni))/c1. In other words, the rank is the number of news items in C times the average feedrank of the feeds from where they were originated.

When clusters are computed for the main page of each category, their ranking is updated continuously. The ordering of the clusters may change. As a general rule, clusters with fresh news items, coming mostly from feeds with high feed rank, are ranked higher. Crowded clusters may also be ranked higher than small clusters. The dynamic cluster is ranking is: DCR(C)=L0*L1*F*A, where L0=Log(1+c0); L1=Log(1+c1); F=SUMi(FW(feedrank(ni))/c1; A=SUM(FRESH(ni))/c1, where c0: the number of unique news items in C; c1: the number of news items in C; FW(ni): a static vector that maps a feedrank into a weight>=1.0; and FRESH(ni): a function that maps linearly the age of the news item in the time interval involved in the clustering process into the interval [1,0). A current news story is assigned FRESH=1, while a news story from the beginning of the time range is assigned FRESH=0. In other words, a cluster has a ranking that is proportional to the log of the number of news items, the log of the number of unique news items, the average freshness of the news items and the average feedrank of the news items.

In one embodiment, the first, for example, twenty clusters (i.e., twenty highest ranked clusters of all clusters) are candidate to join a chain. In another embodiment, clusters with more than m articles are candidate to join a chain. Rewind associates top clusters to chains, which may be stored in a database. A chain is a sequence of semantically connected clusters tracking the evolution of a topic over time. Each time a clustering cycle takes place the top clusters are compared against the existing chains and each of cluster is appended to the chain (i.e., topic) it best matches, or starts a new chain itself. This comparison uses the same techniques described in the cluster merging, as chains are actually clusters spanning over a certain amount of time. The only difference is that labels coming from the chain are also weighted according to the time distance with the labels coming from the candidate cluster, so news stories in the tail of each chain weigh more than news stories at the head.

Near duplicates are articles with very small differences (few different words in the title or in abstract). At the end of the clustering process, the subsets of duplicated or near duplicated news stories are identified. Thus, when the clusters are presented to the user, there is a distribution of the news stories that gives visual variety to the user, so that similar news stories are not shown together. Similarity can be computed with a LCS distance over the titles and over the bodies. The process for computing the similarity distance may be the similar to the process for computing clusters, except the computation is internal to the cluster. In one embodiment, the news system can provide scrambled results to the user that improves visual variety while preserving the original in-cluster ranking, by eliminating the duplicate news articles.

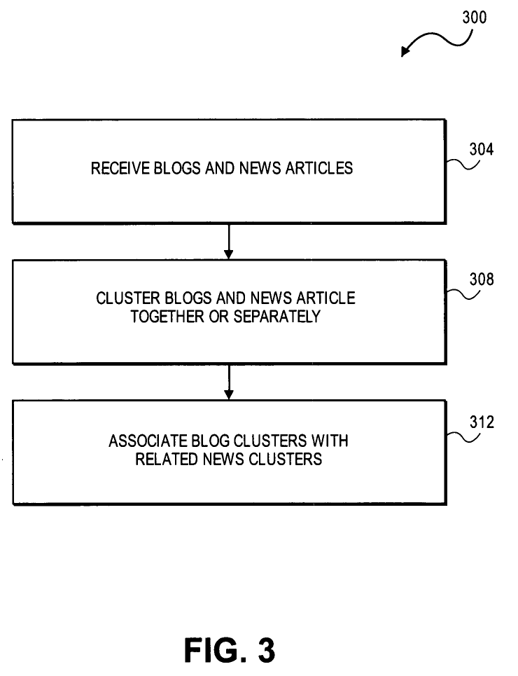

FIG. 3 illustrates a process 300 for clustering multiple types of information in accordance with one embodiment of the invention. In the illustrated embodiment, the multiple types of information are blogs and news articles. It will be appreciated that other types of information may be clustered using the same process. The process 300 begins by receiving blogs and news articles (block 304). The blogs and news articles are then clustered (blog 308). In one embodiment, the blogs and news articles are clustered using the algorithm described above with reference to FIGS. 2-2B. The blogs and news articles can be clustered together or separately. If the blogs and news articles are clustered together they form blog and news clusters. If the blogs and news articles are clustered separately they form separate blog clusters and news clusters. In one embodiment, if the blogs and news articles are clustered together, the blog and news clusters can be split to form separate blog clusters and news clusters. Related blog clusters and news clusters are associated with one another (block 312). The associated blog clusters and news clusters can be presented in the same interface or in separate blog and cluster interfaces, as will be described in further detail hereinafter.

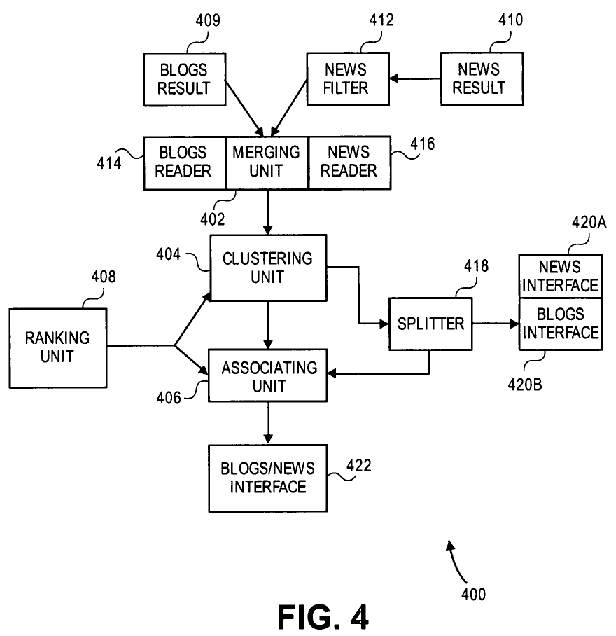

FIG. 4 illustrates a cluster system 400 in accordance with one embodiment of the invention. In one embodiment, the cluster system 400 performs the clustering process 300 of FIG. 3. The cluster system 400 is configured to cluster information of different types, such as, for example, blogs and news articles. In one embodiment, blogs and news articles are clustered together. In one embodiment, the blogs are clustered separate from the news articles, and the blog clusters and news clusters are linked together or otherwise associated with one another.

The illustrated cluster system 400 includes a merging unit 402, a cluster unit 404 and an associating unit 406. The cluster system 400 may include a ranking unit 408. The cluster system 400 may also include a blog receiver 409, a news receiver 410, a news filter 412, a blog reader 414, a news reader 416, a splitter 418, a blog interface 420b and a blogs/news interface 422.

The merging unit 402 merges news articles from the news receiver 410 and the blog receiver 409. The news may also go through a news filter 412 before arriving at the merging unit 402. The merging unit 402 may also be coupled with a blog reader 414 and a news reader 416. The merging unit 402 may also add filtering rules for certain topics. The blog reader 414 converts a blog item into a clusterable object usable by the cluster unit 404 and the news reader 416 converts a news item into a clusterable object usable by the cluster unit 404.

The cluster unit 404 receives the blogs and news articles from the merging unit 402. It will be appreciated that the cluster unit 404 can also receive the blogs and news articles directly from the blog receiver 409 and news receiver 410. The cluster unit 404 clusters the news articles and blogs using the algorithms described above with reference to FIGS. 2-2B. If the cluster unit 404 clusters the news articles and blogs together, the cluster unit 404 creates news article and blog clusters. If the cluster unit 404 clusters the news articles and blogs separately, the cluster unit 404 creates separate news article clusters and blog clusters.

The news and blog clusters can be split at splitter 418 to form separate news clusters and blog clusters. In one embodiment, the separate news clusters and blog clusters are presented in a separate news interface 420a and blog interface 420b, respectively.

The associating unit 406 identifies related news article clusters and blog clusters and links them together. The associating unit 406 may associate clusters from the cluster unit 404 or from the splitter 418.

In one embodiment, the news cluster and blog clusters are ranked at ranking unit 408. The items within each cluster can be ranked at the ranking unit 408. The clusters can also be ranked relative to other clusters at the ranking unit 408. The ranking unit 408 ranks the clusters as described above with reference to FIGS. 2-2B.

Several different ranking criteria may be used by the ranking unit 408. For example, the ranking criteria may include one or more of: (1) a number of different groups of very near duplicates in the cluster; (2) a number of distinct news sources in the cluster; (3) importance of the news sources in the cluster as observed by their past production of important articles or by editorial choices; (4) a number of news articles produced by sources in the same country of the engine; (5) a freshness of the articles in the cluster; (6) a number of images associated with the cluster; (7) a number of videos associated with the cluster; (8) a number of blogs associated with the news cluster; (9) a number of entities associated with a cluster; (10) a length of the chain associated with the cluster; and (11) a number of comments posted by users to the articles in the cluster. It will be appreciated that well-known methods for using the above criteria can be used by the ranking unit 408.

The associating unit 406 fetches clusters in a certain range of time from the cluster unit 404, using a given set of news items as triggers. A correspondence in categories between blogs and news is defined. The correspondence may be nominal or semantical. For example, “Politics,” which exists as politics in both articles blogs, while “Blog-Gossip” and “News-Entertainment” is used for blogs and articles, respectively, for the similar topic of gossip and entertainment news. An overlap between time ranges can be identified for establishing a connection between the blogs and the news articles at the associating unit 406.

News articles tend evolve in constrained time slots, while blogs tend to be more spread over time and blog topics tend to be more fragmented than news articles. News stories can “drive” the correlation or blogs can “drive” the correlation. If the news stories drive the correlation, blogs are examined to identify comments on dominant news stories. If blogs drive the correlation, the system searches for news stories of which bloggers are commenting. It will be appreciated that it may be preferable to let blogs drive the correlation because blogs tend to semantically dominate the topics and can give the most important ranking hints to the whole picture (the most important story is perhaps what people are mostly commenting about rather that what editors are mostly writing about), and the information can be inherited in a bottom-up fashion.

In one embodiment, the first two levels of feedrank drive the correlation process. In one embodiment, the time frame selected for clustering is a sliding 3-day time window. The first two levels of feedrank of news with the blog items over, for example, a three day time range. Throughout the clustering process, each item in a cluster may keep a stamp of the domain (news, blog) it belongs to, so the news and blog items can optionally be separated at a later time.

The clustering process produces a set of clusters which are made both of news items and blogs items. The clusters Cᵢ, i>0, include a news items N and blog items Bᵢ. The news items can be filtered out. The clusters can also be ranked. The blogs Bᵢ can then be presented as a cluster of blogs. In one embodiment, for each news item nᵢⱼ in Nᵢ, the set Mᵢₖ of already computed news clusters that contain that news item is extracted. The remaining set of clusters is the set of news clusters related to the blog cluster Bᵢ. The result is a set of “driving” blog clusters, each blog cluster having an associated news cluster.

The ranking unit 408 ranks the articles and/or blogs in the clusters from the cluster unit 404 (i.e., articles and blogs in same cluster) or from the associating unit 406 (i.e., articles and blogs in separate clusters). The ranking unit 408 ranks the articles and/or blogs and resulting clusters, as described hereinabove with reference to FIGS. 2-2B.

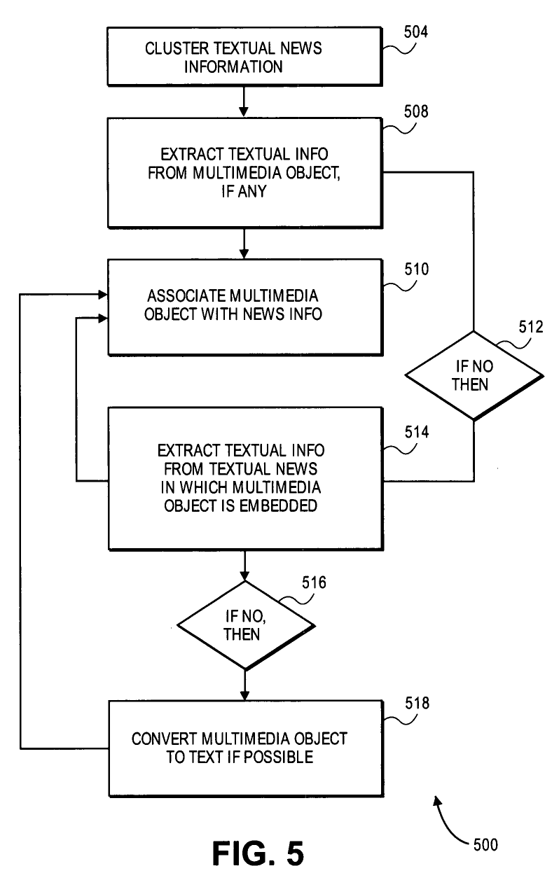

FIG. 5 illustrates a process 500 for associating a multimedia object with cluster and/or chain. For example, the multimedia object can be a video and/or image. In one embodiment, the association process takes place in two or more steps according to the amount of meta-information that comes together with the multimedia object, as shown in FIG. 5.

The process 500 begins by clustering textual news information (block 504). Exemplary textual news information includes, for example, news articles, blogs, and the like. Textual information is extracted from multimedia objects (bock 508). In some cases, the multimedia object may not have any textual information. The extraction can exploit available meta data or speech-to-text technologies. The extracted textual information is compared with textual news information to associate the multimedia object with the news information. (block 510). Metadata information is extracted from the multimedia objects to form a set of tags for the multimedia object. As discussed above, each cluster includes a set of labels. The set of tags for the multimedia object is matched with the set of labels for the clusters. For each cluster, the multimedia object that best matches the labels, over a certain threshold, is associated with the cluster.

If there is no textual information associated with the multimedia object (block 512), then textual information is extracted from the textual news information with which the multimedia object was embedded (block 514). The textual information extracted from the textual news information is then compared with the textual news information to associate the multimedia object with the news information (block 510).

If the multimedia object is still not associated with a cluster (block 516), then the multimedia object is converted to text if possible (block 518). The conversion data is then compared with the cluster to associate the multimedia object with a cluster (block 510).

The multimedia objects can also be ranked. Ranking of the multimedia objects may be a function of one or more of visual quality, feedrank of the source that provided the multimedia object, freshness, media type, degree of replication, and the like. For visual quality, if the multimedia object is an image, the visual quality analysis may consider: a) entropy computation to analyze the amount of details of the picture; b) compression factor of the source data; c) chromatic variance; and, d) image aspect ratio. For visual quality, if the multimedia object is a video, the format analysis may include a) mean original quantization factor; and b) bits per pixel ratio. The media score for the multimedia object may also take into account the feedrank of the source that produced the object. The ranking may also consider the freshness of the article with which the multimedia object is associated. In one embodiment, one media type, such as, for example, videos are ranked higher than, for example, photographs, another media type. The degree of replication of the media in the set may be identified using wavelet based near duplicate detection techniques.

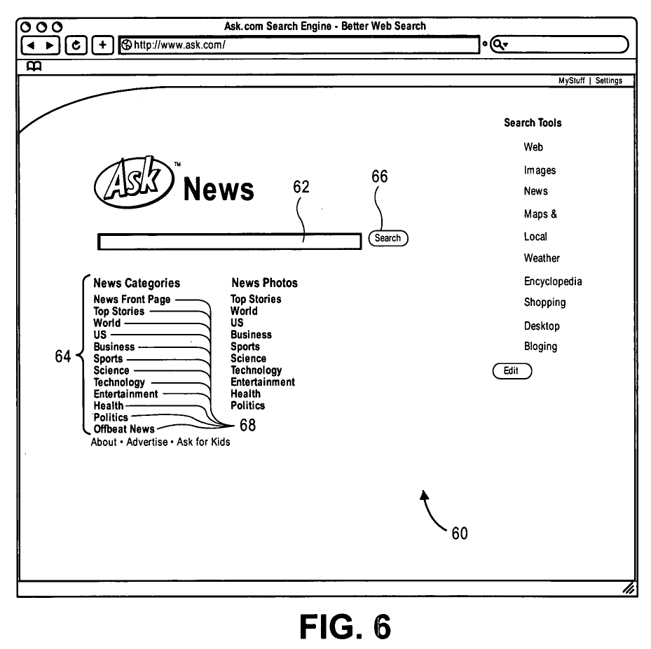

FIG. 6 shows an exemplary user interface 60 for selecting news information in accordance with one embodiment of the present invention. The user interface 60 may be connected to or may be otherwise related to the news information interface 32 (FIG. 1).

The user interface 60 includes a search box 62 and a list of selectable news categories 64.

The search box 62 may also include a selectable button 66. Users of the user interface 60 enter a search query into the search box 62 and select the selectable button 66 to search for news information related to the search query. The search query may be, for example, a keyword search or a natural language search.

The list of selectable news categories 64 may include selectable links 68 corresponding to each of the categories in the list of selectable news categories 64. Users of the user interface 60 select one of the selectable links 68 from the list of selectable news categories 64 to link to browsable news information relating to the selected news category. It will be appreciated that any number or type of news category may be presented to a user for selection. For example, the illustrated news categories 64 include top stories, world, U.S., business, sports, science, technology, health, politics, entertainment and offbeat news.

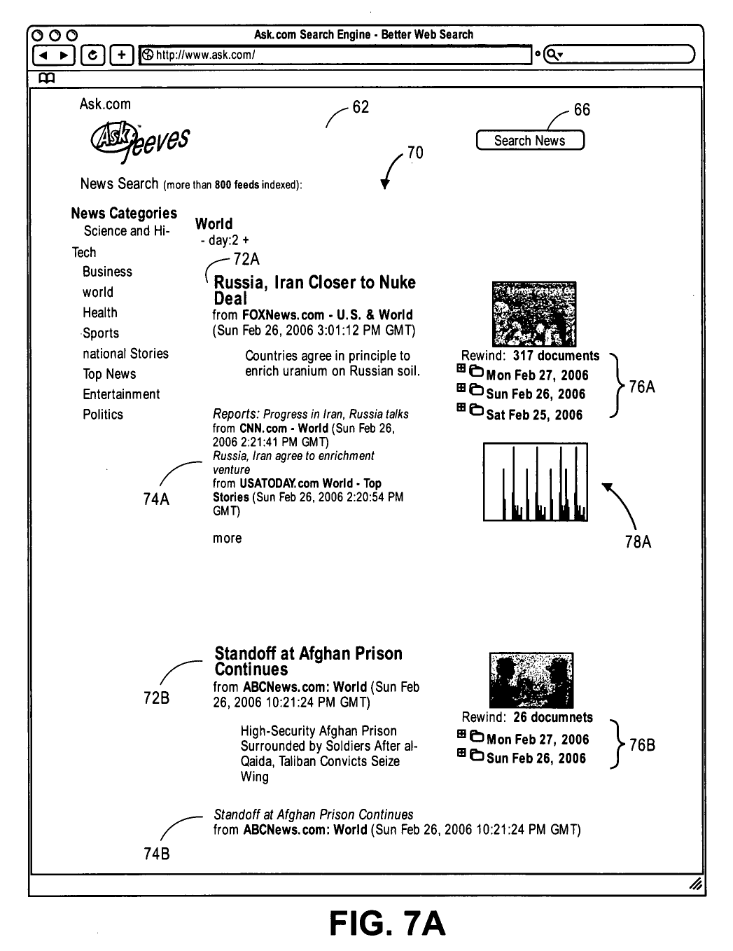

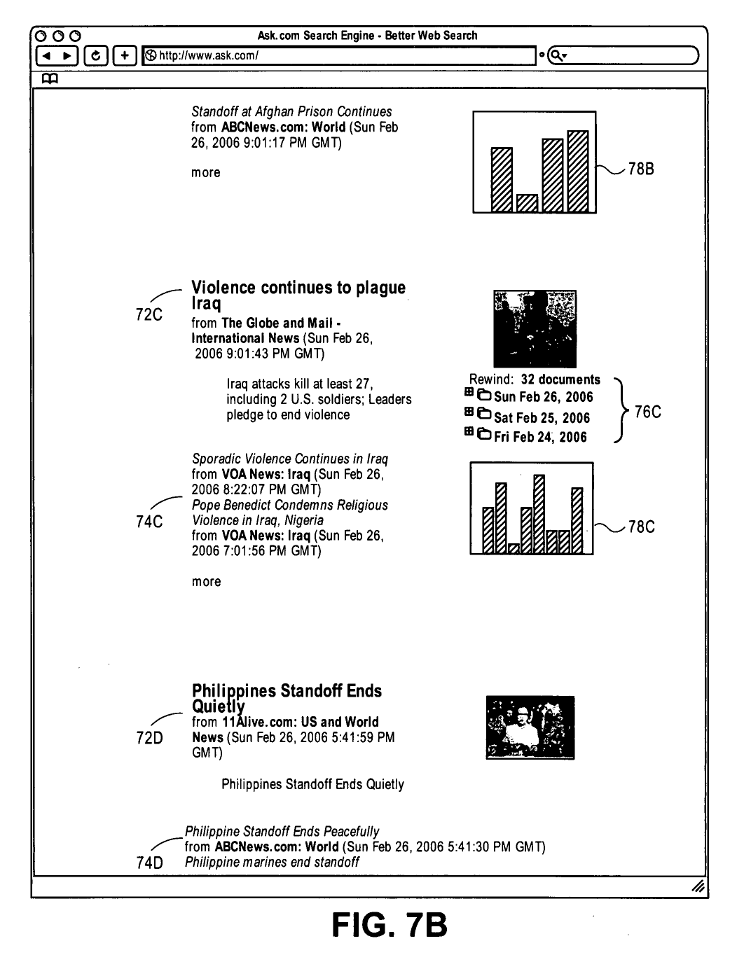

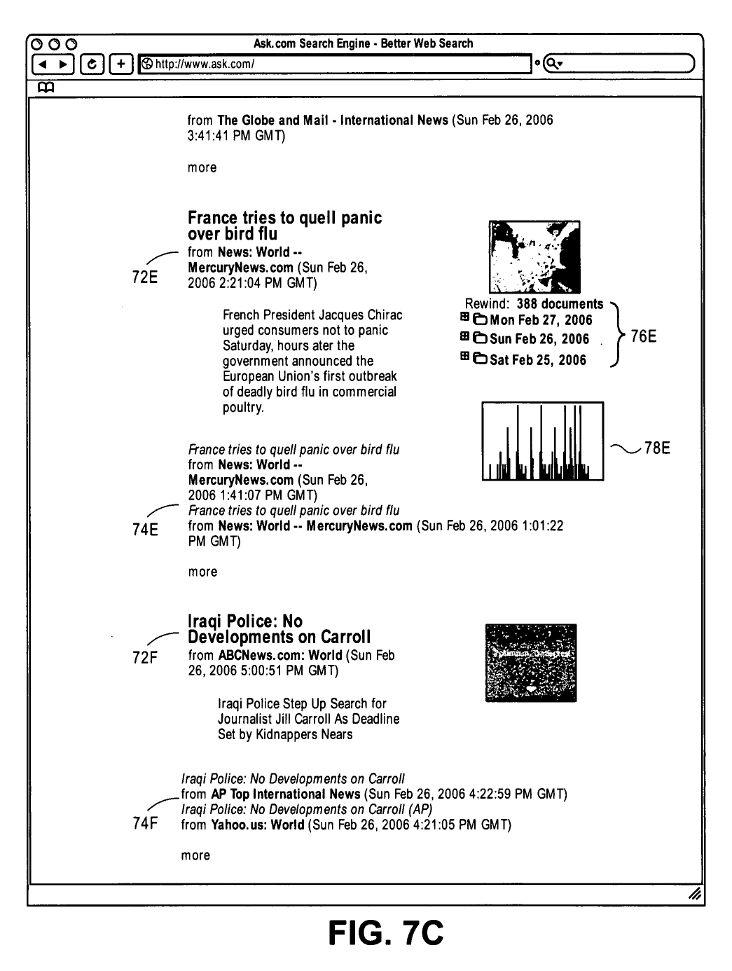

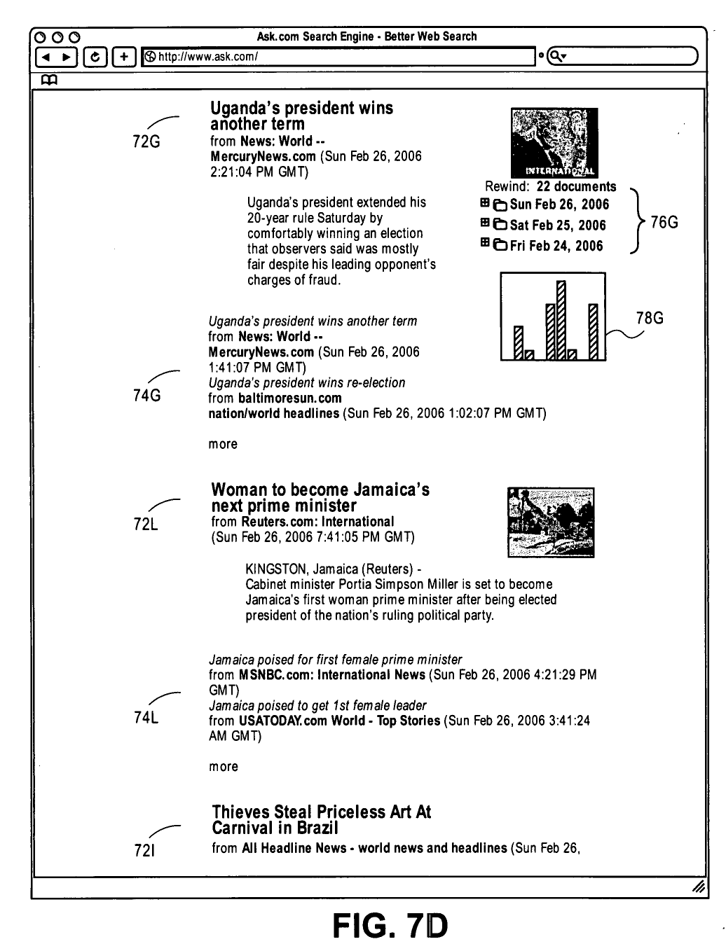

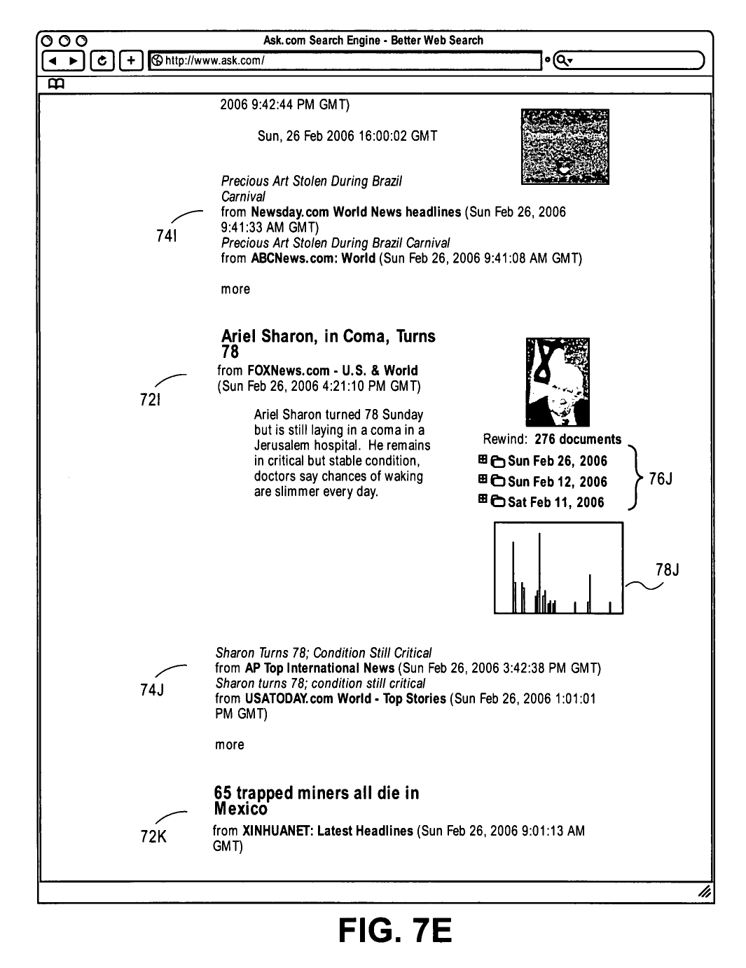

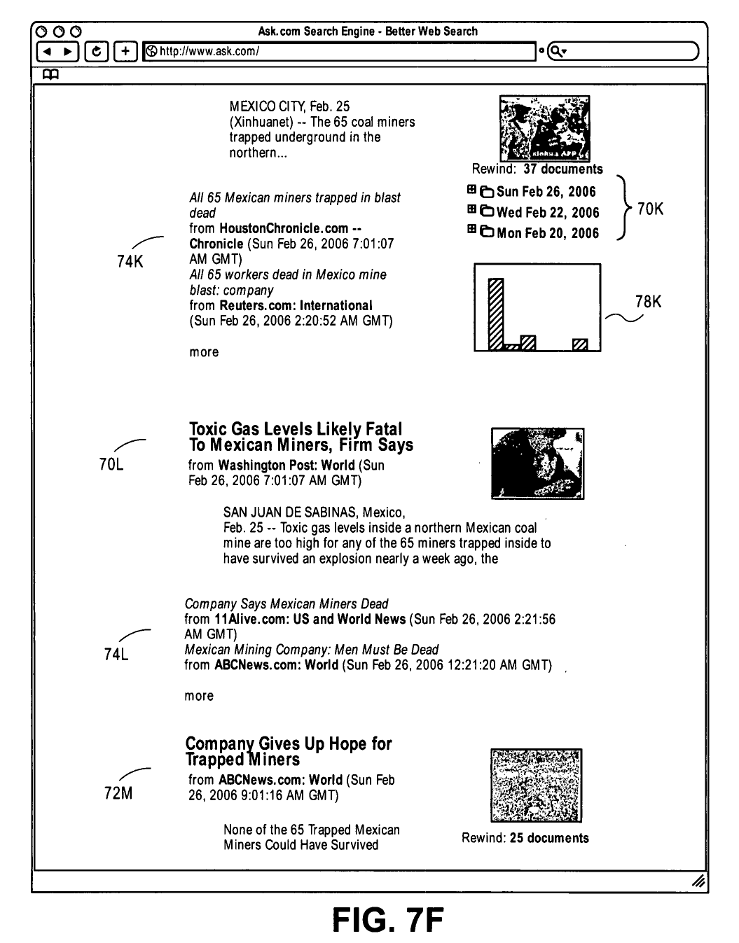

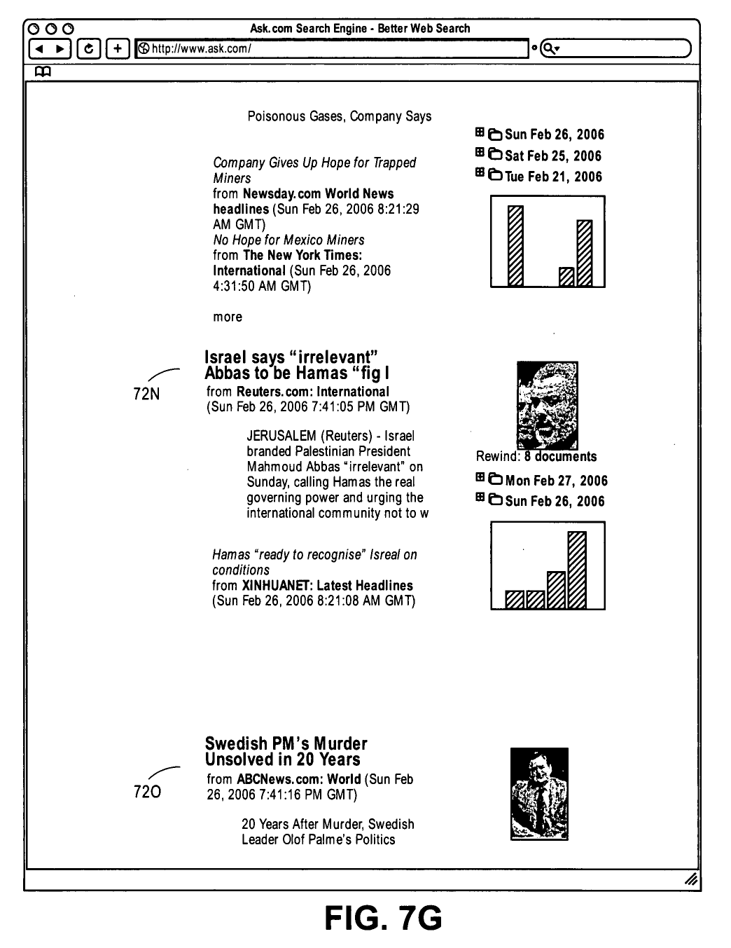

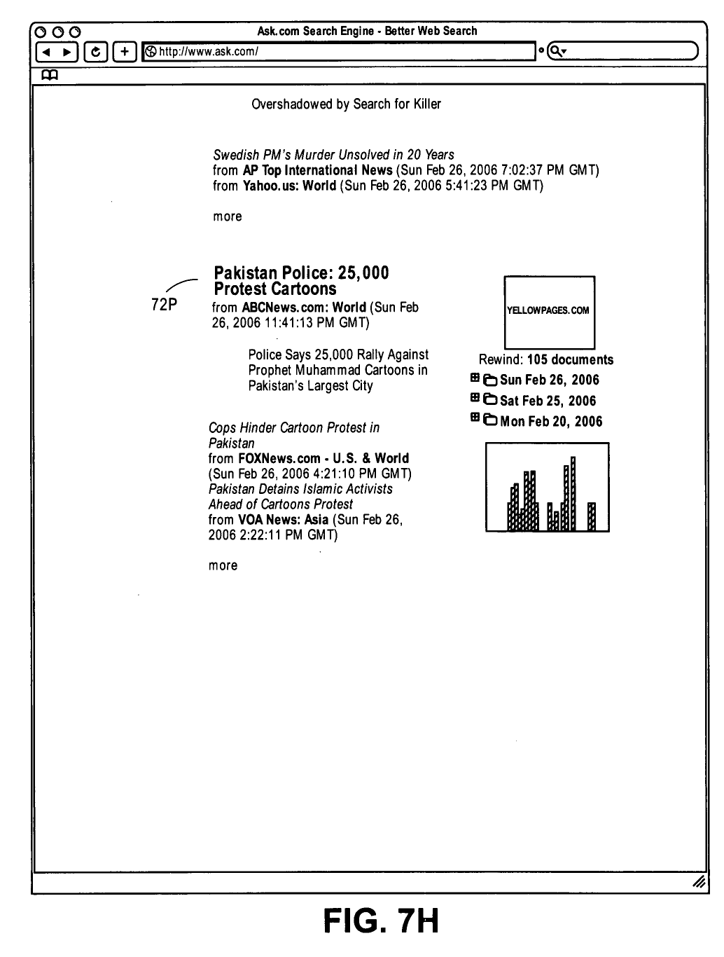

FIGS. 7A-7H illustrate an exemplary user interface 70 for browsing news information related to a selected news category in accordance with one embodiment of the present invention. The illustrated user interface 70 is typically presented to a user in response to a selection of one of the categories 64 in the user interface 60. The illustrated user interface 70 is directed to “world” news information, based on a user selection of the “world” news category link from the list of categories 64 in the user interface 60.

As illustrated in FIG. 7A, the user interface 70 includes a list of representative news stories 72a-72o, related news stories 74a-74o, temporal information 76a-76o and a histogram 78a-78o. The user interface 70 may also include a search box 62 and selectable button 66, as described above with reference to FIG. 6.

The list of representative news stories 72a-72o, related news stories 74a-74o, temporal information 76a-76o and histogram 78a-78o together represent a topic cluster.

It will be appreciated that not all of the representative news stories 72a-72o will have related news stories, temporal information or histograms. For example, new story 72d does not include temporal information or a histogram.

The representative news stories 72a-72o are typically presented with a title corresponding to the news story and may include other information about the news story, such as, for example, the source, news category, publication or posting date and/or time, a brief summary, and a multimedia object. The multimedia object may include one or more of an image, video, audio, and the like and combinations thereof.

Similarly, each of the related news stories 74a-74o may include the title, source, news category, publication or posting date and/or time, a brief summary, and a photograph (or different media types, such as, for example, video). The related news stories 74a-74o are determined to be related to the representative news stories 72a-72o using the algorithm described above or using any other method for determining relatedness among stories.

The temporal information 76a-76o corresponds to temporal clusters for a topic corresponding to each of the news stories 72a-72o. The illustrated temporal information 76a-76o relates to the publication date; however, other temporal information can be used, as described above. One or more temporal clusters together may illustrate a chain or a portion of a chain of temporal clusters corresponding to the topic.

The histograms 78a-78o are a graphical representation of the temporal information for the topic cluster (i.e., a graphical representation of the temporal cluster for a given topic).

Users can select on any of the representative news stories 72a-72o, related news stories 74a-74o, temporal information 76a-76o or histograms 78a-78o to access more information about the new article, topic cluster and/or temporal cluster. For example, if the user selects the representative news stories 72a-72o or the related news stories 74a-74o, the user is typically presented with the news article corresponding to the selected story. If the user selects the temporal information 76a-76o, the user is typically presented with the temporal cluster for the selected topic, as will be described in more detail hereinafter. If the user selects the histogram 78a-78o, the user is typically presented with a larger image of the histogram and, optionally, the temporal cluster for the selected topic, as will be described in more detail hereinafter. It will be appreciated that the user can also select a multimedia object (e.g., an image, video, etc.) to access more information about the news story.

For example, with reference to FIG. 7E, news title 72j is “Ariel Sharon Turns 78.” A summary of related news story 74j is also provided. The title 72j and related news titles 74j correspond to a topic cluster relating to Ariel Sharon. The illustrated temporal information 76j corresponds to the publication date of stories related to Ariel Sharon's coma. A histogram 78j may also be provided with the news article 72j. The histogram 78j includes a graphical representation of the temporal information for the Ariel Sharon topic cluster.

As described above, the user can select on the representative news story 72j, related news stories 74j, temporal information 76j, histograms 78j, or a multimedia object to access more information about the selected article and/or temporal cluster for the Ariel Sharon story.

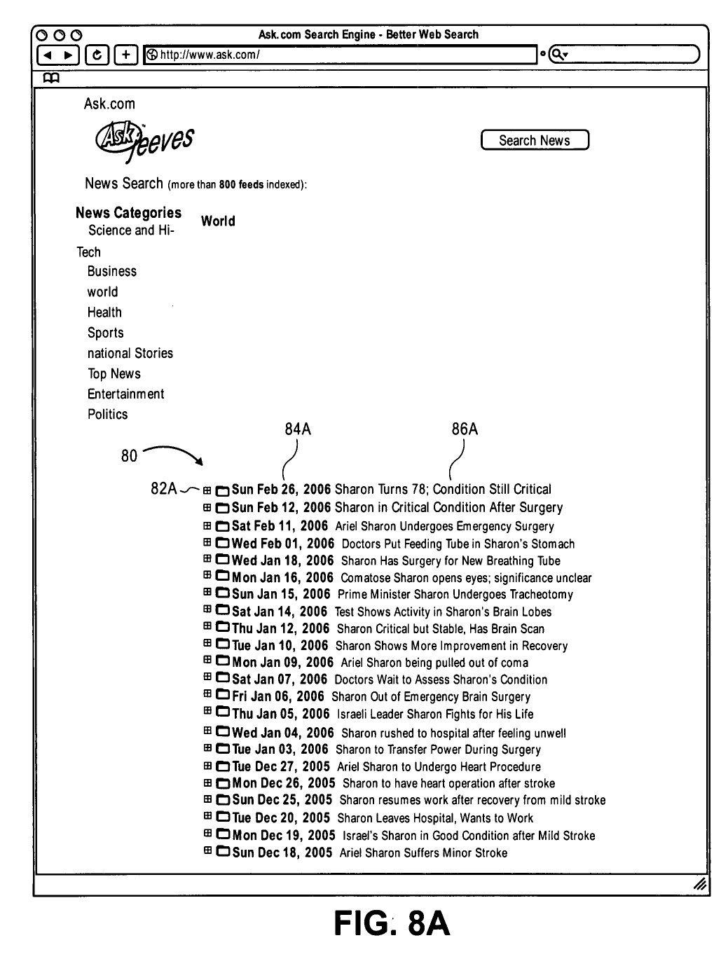

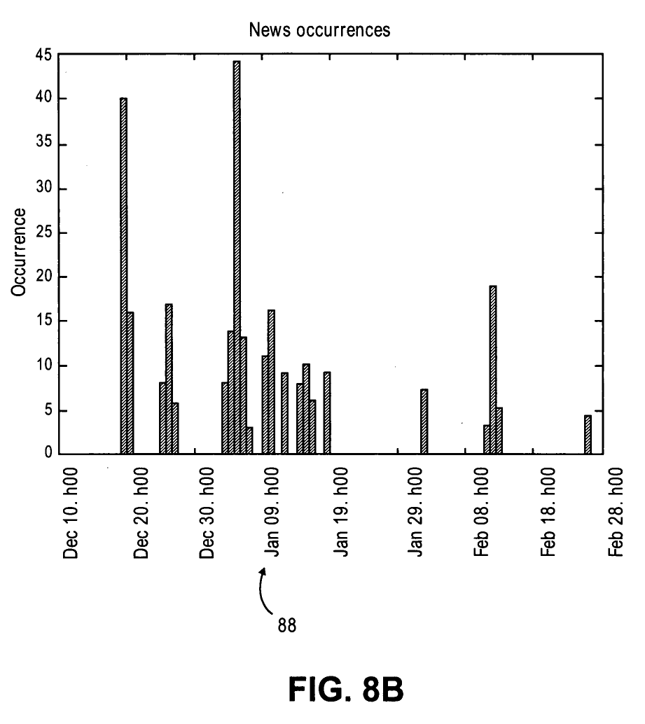

FIGS. 8A and 8B show a user interface 80 for presenting clustered news information in accordance with one embodiment of the invention. FIGS. 8A and 8B also illustrate a chain of clustered news articles. The user interface 80 is accessible from a browsable interface, as described above with reference to FIGS. 7A-7H, or from a search query interface, as described above with reference to FIG. 6. In particular, the user interface 80 is typically accessible by selecting the temporal information or histogram from the browsable interface. Alternatively, the user interface 80 may be accessible from a link included in a selected article allowing a user to access additional information about the selected article.

The user interface 80 includes a plurality of clusters 82, a publication date 84 and a representative title 86. The clusters 82 each correspond to a temporal cluster. The clusters 82 together represent a chain of temporal clusters for a particular news story. A user, can therefore, see the temporal evolution of the story from the hierarchy of clusters shown in FIG. 8A.

A user can select the date, title or a defined area or icon near the cluster 82 to access the news article and/or expand the cluster 82. It will be appreciated that the user can also select a multimedia object to access the news article and/or expand the cluster 82.

The illustrated story is related to the topic of Ariel Sharon's coma and the temporal information used to cluster the information is the publication date.

As shown in FIG. 8B, the user interface 80 may also include a histogram 88. It will be appreciated that the histogram 88 can be on a separate user interface, such as, by providing a link from the user interface 80 illustrated in FIG. 8A.

The histogram 88 also shows the hierarchy of temporal clusters related to a selected topic cluster. The hierarchy of clusters illustrates the temporal evolution of a particular news story.

From the illustrated histogram 88, it can be seen that there was a spike in news articles in the topic cluster around December 18 and January 3. Returning to the list of temporal clusters 82 shown in FIG. 8A, it can be seen that the spikes correspond to articles corresponding to Ariel Sharon's stroke and the determination to transfer of power, respectively. Thus, users can use the histogram 88 to evaluate the temporal evolution of the news story graphically.

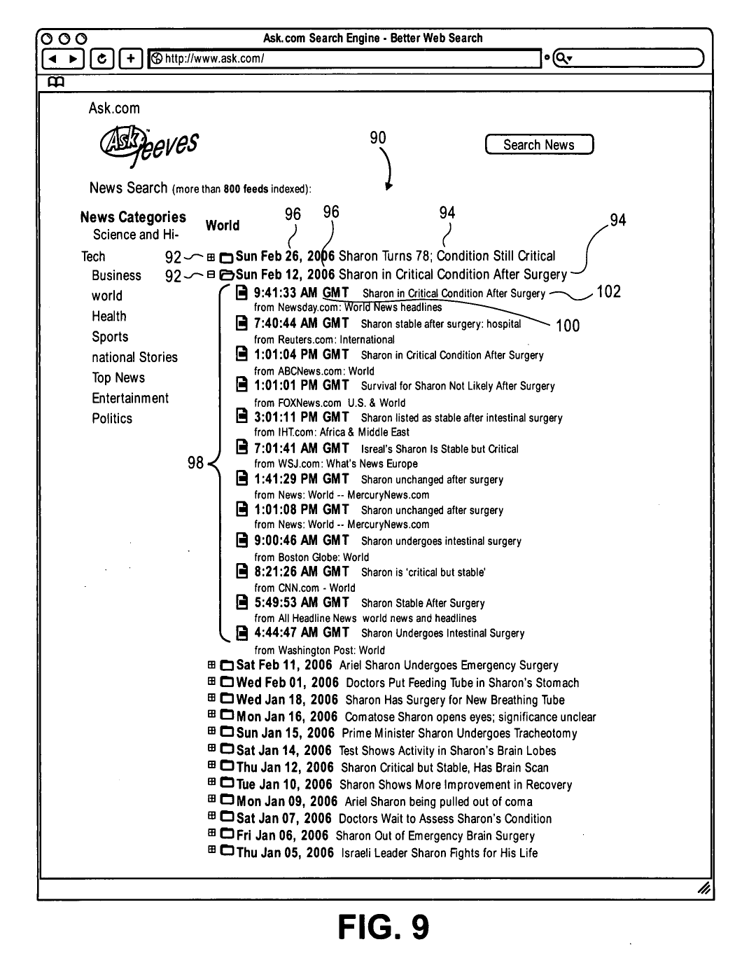

FIG. 9 shows an exemplary user interface 90 having an expanded cluster 92.

Each cluster 92 is identified with temporal information 94 and a representative title 96. The cluster 92 is expandable with a user selection of the cluster 92 or a defined area near the cluster 92. It will be appreciated that the cluster 92 can also be identified with a multimedia object.

The expanded cluster 92 includes a plurality of news stories 98. Each of the plurality of news stories 98 includes a publication time 100 and a title 102. A user can select any of news stories 98 to access the full article.

Although user interface 90 has been described with respect to the publication date as the temporal information, it will be appreciated that the temporal information may alternatively be the posting date, clustering date or crawling date, as described hereinabove.

Thus, with user interfaces 80 and 90, the user is able to browse the topic and/or temporal clusters and browse within the chains. A user can follow the temporal evolution along the chain of clusters. That is, a user can “jump” within a chain of clusters, moving forward and/or backward through the chain.

When a user enters a search query, the most relevant articles and/or clusters in a chain are typically provided as the search result. The user can follow the temporal evolution moving back and forth within the chain with user interfaces 80 and 90 using a search query, as well.

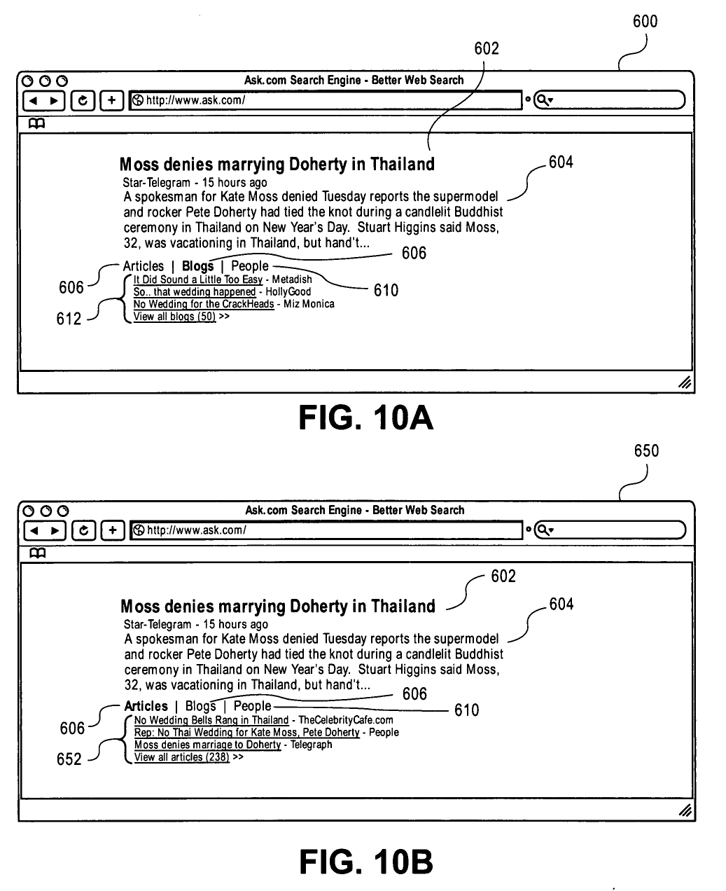

FIGS. 10A and 10B illustrate an exemplary news cluster interface and blog cluster interface. The interfaces of FIGS. 10A and 10B allow the user to switch between two browsing modes: blogs and news. In FIG. 10A, a blog cluster 600 is illustrated. The illustrated blog cluster 600 includes a title 602 and a summary 604 associated with the blog cluster 600. The blog cluster 600 also includes links 606, 608 and 610 to articles, blogs and people, respectively. In FIG. 10A, the link 608 corresponding to blogs is highlighted to indicate a blog cluster is displayed. The blog cluster 600 also includes a list 612 of exemplary blog links in the blog cluster. In FIG. 10B, a news cluster 650 is illustrated. The illustrated news cluster 650 also includes a title 602 and summary 604 associated with the news cluster 650. The news cluster 650 also includes links 606, 608 and 610; however, in FIG. 10B, the link 606 corresponding to articles is highlighted to indicate a news cluster is displayed. The news cluster 650 also includes a list 652 of exemplary news articles in the news cluster.

An advantage of the systems and methods described herein is that by clustering a stream of information according to the topic and temporal information and linking the related clusters in chains according to the temporal information, a historical evolution of the story can be presented to users. The user can navigate through the chain using rewind and forward links in the articles that allow a user to move through the evolution of the story. Another advantage of the systems and methods described herein is that information is determined to be related using a clustering algorithm that reveals paths in the evolution of a news story. In addition, search results can be improved because users are presented with more detailed information. Another advantage of the systems and methods described herein is ranking. Chains and Clusters are an important tools for ranking because certain articles can be given more importance. For example, articles which are produced by an important news source, are fresh (e.g. produced recently), belong to a dense cluster (e.g. an hot topic), for a fixed day, have a temporal importance which can be inferred by the chain may be ranked higher. In addition, 1) a long chain/high density of recent articles is more important than a short/low density chain of recent articles, 2) a long chain/high density of recent articles is more important than a long chain/low density of old articles, 3) a short chain/low density of recent articles may be more important than a long chain of old articles, etc. Thus, clusters and chains can be used to effect importance ranking. Another advantage of the systems and methods disclosed herein is that blogs and blog clusters can be associated with the news clusters. A separate blog cluster interface can also be provided to users. In addition, multimedia objects can be associated with the cluster to provide additional information about a news and/or blog cluster.

The foregoing description with attached drawings is only illustrative of possible embodiments of the described method and should only be construed as such. Other persons of ordinary skill in the art will realize that many other specific embodiments are possible that fall within the scope and spirit of the present idea. The scope of the invention is indicated by the following claims rather than by the foregoing description. Any and all modifications which come within the meaning and range of equivalency of the following claims are to be considered within their scope.

1. A computer-implemented method for presenting information comprising:
receiving textual news information;
clustering the textual news information to form a plurality of topic clusters;
identifying textual information associated with visual news information;
associating visual news information with at least one of the plurality of topic clusters using the textual information; providing the visual news information with the at least one of the plurality of topic clusters.

2. The method of claim 1, wherein the textual news information comprises news articles.

3. The method of claim 1, wherein the textual news information comprises blog articles.

4. The method of claim 1, wherein the visual news information comprises images.

5. The method of claim 1, wherein the visual news information comprises videos.

6. The method of claim 1, wherein the textual information comprises metadata.

7. The method of claim 5, wherein identifying textual information associated with visual news information comprises converting audio data of the video to textual information.

8. The method of claim 7, further comprising ranking the plurality of topic clusters.

9. The method of claim 7, further comprising ranking the textual news information in each of the plurality of topic clusters.

10. A computer-implemented method for organizing related news information comprising:
receiving differing news information types;
merging the differing news information types to form merged news information;
clustering the merged news information to form a plurality of topic clusters; and
providing the plurality of topic clusters,
wherein the differing news information types are selected from the group consisting of articles, blogs, images and videos.

11. The method of claim 10, wherein merging differing news information types to form merged news information comprises merging articles and blogs.

12. The method of claim 11, further comprising associating a multimedia object with the topic clusters.

13. The method of claim 12, wherein the multimedia object is selected from the group consisting of images, videos and combinations thereof.

14. A search system comprising:
a news information receiver to receive news information, wherein the news information comprises textual information and multimedia objects;
a merging unit to merge the textual news information; and
a cluster unit to cluster the textual news information according to a topic of the news information.

15. The search system of claim 14, further comprising a server to present the news information to a user.

16. The search system of claim 15, further comprising a search engine connected to the server, the search engine to receive a search query of the news information.

17. The search system of claim 16, wherein the server is to provide a search result to the search engine in response to the search query.

18. The search system of claim 14, further comprising a ranking unit to rank clustered news information.

19. The search system of claim 14, further comprising an associating unit to associate the multimedia objects with the clustered news information according to the topic of the news information.

20. The search system of claim 19, wherein the multimedia objects are selected from the group consisting of images, videos and combinations thereof.

21. The method of claim 8, wherein ranking comprises considering one or more of: a number of different groups of very near duplicates in the cluster, a number of distinct news sources in the cluster, importance of the news sources in the cluster as observed by their past production of important articles or by editorial choices, a number of news articles produced by sources in the same country of the engine, a freshness of the articles in the cluster, a number of images associated with the cluster, a number of videos associated with the cluster, a number of blogs associated with the news cluster, a number of entities associated with a cluster, a length of the chain associated with the cluster, and a number of comments posted by users to the articles in the cluster.

22. The search system of claim 18, wherein the ranking unit is to consider one or more of: a number of different groups of very near duplicates in the cluster, a number of distinct news sources in the cluster, importance of the news sources in the cluster as observed by their past production of important articles or by editorial choices, a number of news articles produced by sources in the same country of the engine, a freshness of the articles in the cluster, a number of images associated with the cluster, a number of videos associated with the cluster, a number of blogs associated with the news cluster, a number of entities associated with a cluster, a length of the chain associated with the cluster, and a number of comments posted by users to the articles in the cluster.
